(19) United States
(12) Patent Application Publication
(10) Pub. No.: US 2010/0162169 A1
(43) Pub. Date: Jun. 24, 2010

(54) Method, Apparatus and Computer Program Product for Providing a Dynamic Slider Interface

(75) Inventor: Ari-Pekka Skarp, Oulu (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/342,136

(22) Filed: Dec. 23, 2008

(51) Int. Cl. G06F 3/048

(52) U.S. Cl. 715/833

(57) ABSTRACT

An apparatus for providing a slider interface module for use with touch screen devices may include a processor. The processor may be configured to identify a selected functionality option based on a detected first slider selection event on a touch screen display. The processor may also be configured to present, in response to identifying the selected functionality option, at least one sub-functionality option on the touch screen display based on the selected functionality option, the at least one sub-functionality option being selectable via a second slider selection event. A corresponding method and computer program product are also provided.

### TECHNOLOGICAL FIELD

Embodiments of the present invention relate generally to user interface technology and, more particularly, relate to a method, apparatus, and computer program product for providing a dynamic slider interface for use with touch screen devices.

### BACKGROUND

With the evolution of computing and communications devices, new and unique ways for users to interface with electronic devices, such as a computers, cell phones, mobile terminals, or the like, are continuously evolving. Initially, user interfaces for electronic devices were limited to hard keys, such as the numeric keys on the keypad of a cell phone. Hard keys provided a means for a user to interface an electronic device via mechanical actuation of the key. In many instances, a hard key performed the exact same functionality each time the key was pressed. Due to the lack of flexibility of hard keys, developers created the concept of soft keys. Soft keys may also be mechanically actuated, but the functionality underlying the key can be software configured. In this manner, the functionality performed when a soft key is pressed may change based on how an application has configured the soft key. For example, in some applications a soft key may open a menu, and in other applications the same physical key may initiate a phone call.

User interfaces of electronic devices have recently taken another leap with the advent of the touch screen display. Touch screen displays eliminate the need for mechanical keys on an electronic device and are readily configurable via software to support a unique user interface to any application executed by an electronic device. As an output device, a touch screen display may operate similar to a conventional display. However, as an input device, a user may interact directly with the display to perform various operations. To replace the functionality provided by the conventional mechanical keys, touch screen displays can be configured to designate areas of the display to a particular functionality. Upon touching a designated area on a touch screen display with, for example a finger or a stylus, the functionality associated with the designated area may be implemented.

While touch screen displays offer an improved interface for a user that can be software configured for maximum flexibility, touch screens also have some drawbacks. For example, unintended or accidental contact with the touch screen display may result in the electronic device performing undesirable operations. As such, a touch screen display device in the pocket of a user may inadvertently be contacted and an operation such as the initiation of a phone call may occur. Further, in some instances even when a user intends to be perform particular operations on a touch screen display device, stray or unintended movement while interfacing the touch screen display may again cause unintended operations to be performed by the device.

### BRIEF SUMMARY

A method, apparatus and computer program product are therefore described for providing a dynamic slider interface for use with touch screen devices. In this regard, example embodiments of the present invention implement a slider interface object that allows a user to select a functionality option (e.g., answer an incoming call, send a text message, shut down the device, etc.) by moving a virtual slider object on a touch screen display to a location on the display that is associated with a desired functionality option. In this regard, movement of the slider object to a location for selecting a functionality option may be referred to as a slider selection event. A processor may be configured to detect a slider selection event by interfacing with the touch screen display. In response to identifying a selected functionality option, one or more sub-functionality options (e.g., enable speaker phone, enter reduced power mode, send a text message, etc.) may be dynamically presented on the touch screen display. The functionality options previously available may be removed from the touch screen display and sub-functionality options may be presented, thereby making efficient use of the screen space. The sub-functionality options that are presented upon a slider selection event directed to a functionality option may have an intuitive relationship with the functionality option. In this regard, a hierarchal tree of functionality options may be available to a user. A sub-functionality option may be selectable via a subsequent slider selection event directed to a desired sub-functionality option. Various operations may be executed based on the selected functionality option and/or the selected sub-functionality option.

One example embodiment of the present invention is a method for providing a dynamic slider interface for use with a touch screen display. The example method includes identifying a selected functionality option based on a detected first slider selection event on a touch screen display. The example method further includes presenting, in response to identifying the selected functionality option, at least one sub-functionality option on the touch screen display based on the selected functionality option. In this regard, the at least one sub-functionality option may be selectable via a second slider selection event. Further, presenting the at least one sub-functionality option on the touch screen display may be performed via a processor.

Another example embodiment is an apparatus including a processor. The processor may be configured to identify a selected functionality option based on a detected first slider selection event on a touch screen display. The processor may be further configured to present, in response to identifying the selected functionality option, at least one sub-functionality option on the touch screen display based on the selected functionality option. In this regard, the at least one sub-functionality option may be selectable via a second slider selection event.

Yet another example embodiment of the present invention is a computer program product. The computer program product may include at least one computer-readable storage medium having executable computer-readable program code instructions stored therein. The computer-readable program code instructions may be configured to identify a selected functionality option based on a detected first slider selection event on a touch screen display. The computer-readable program code instructions may be further configured to present, in response to identifying the selected functionality option, at least one sub-functionality option on the touch screen display based on the selected functionality option. In this regard, the at least one sub-functionality option may be selectable via a second slider selection event.

Another example embodiment of the present invention is an apparatus. The example apparatus includes means for identifying a selected functionality option based on a detected first slider selection event on a touch screen display. The example apparatus further includes means for presenting, in response to identifying the selected functionality option, at least one sub-functionality option on the touch screen display based on the selected functionality option. In this regard, the at least one sub-functionality option may be selectable via a second slider selection event.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1a-1d illustrate the operation of a dynamic slider interface in accordance with various example embodiments of the present invention;

FIG. 2 is block diagram representation of an apparatus for providing a dynamic slider interface according to various example embodiments of the present invention; and

FIG. 3 is a flowchart of a method for providing a dynamic slider interface according to various example embodiments of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, operated on, and/or stored in accordance with embodiments of the present invention. Moreover, the term “exemplary,” as used herein, is not provided to convey any qualitative assessment, but instead to merely convey an illustration of an example.

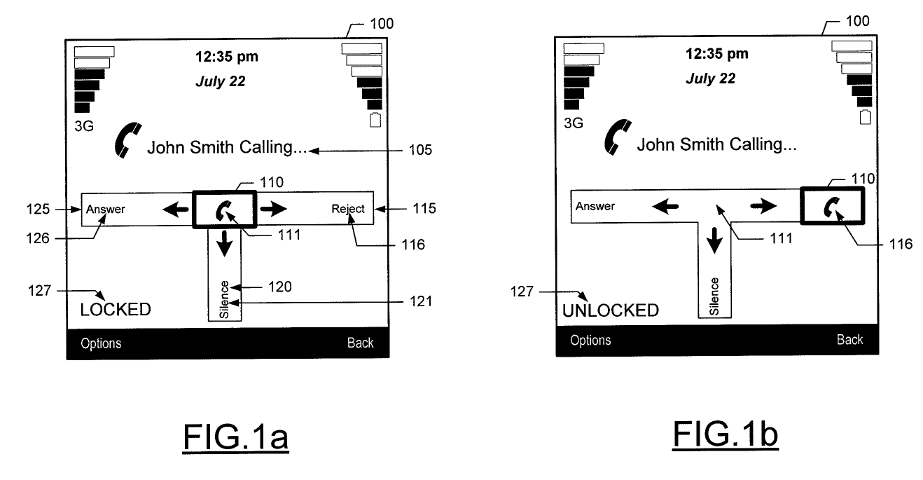

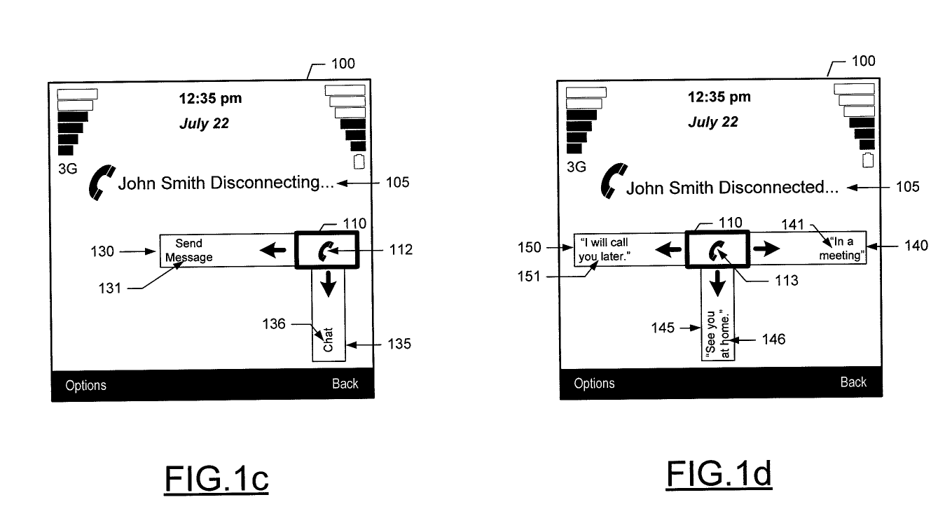

FIGS. 1a through 1b are illustrations of an example scenario of an implementation of a dynamic slider interface according to example embodiments of the present invention. FIG. 1a depicts a touch screen display 100 presenting an example dynamic slider interface. The touch screen display 100 may be incorporated into the user interface of FIG. 1a of any electronic device, such as a mobile terminal. The example dynamic slider interface includes a device status 105, a slider object 110, a reject option 115, a silence option 120, an answer option 125, and a display locked/unlocked status 127. The device status 105 may indicate a current operation being performed by the electronic device including touch screen display 100 (e.g., receiving a phone call).

In various example embodiments, the slider object 110 is a virtual object that is movable via interaction with the touch screen display 100. In this regard, contact with the touch screen display 100, via for example a finger or a stylus, at the current location of the slider object 110 and subsequent movement while still in contact with the touch screen display may cause the slider object 110 to be presented as moving in unison in the same direction as the movement.

The reject option 115, the silence option 120, and the answer option 125 may be examples of selectable functionality options in accordance with example embodiments of the present invention. The functionality options may be selected by moving the slider object 110 from a first origin location 111 to a functionality option location associated with a functionality option. In this regard, functionality option location 116 is associated with the reject option 115, functionality option location 121 is associated with the silence option 120, and functionality option location 126 is associated with the answer option 125. While FIG. 1a depicts functionality options that are to the left, the right and below the origin location 111, it is contemplated that embodiments of the present invention may be provided for functionality options and sub-functionality options are oriented in any position relative to the origin location (e.g., above, forty-five degree angle, etc.). Further, in some example embodiments, a non-linear path between the origin location and the functionality option location may be implemented.

By moving the slider object 110 from the origin location 111 to one of the functionality option locations 116, 121, 126, a functionality option may be selected. The movement of the slider object 110 from an origin location to a functionality option location, which may also be referred to as a destination, to select the underlying functionality option may be referred to as a slider selection event. For example, if a user contacts the touch screen 100 and then, in continued contact with the touch screen, moves the slider object 110 from origin location 111 to a destination that is functionality option location 116, then a slider selection event may have been implemented and the functionality associated with the reject option 115 may be selected.

Because a slider selection event, in some exemplary embodiments, includes movement on a touch screen display in the direction of a functionality option location until the functional option location is reached, a slider selection event may be considered to be a reliable indicator of a user's intent to perform particular functionality associated with the functional option location. According to various embodiments, by receiving input from a user via a slider selection event, the probability of unintended or accidental selection of functionality is reduced.

Further, in some example embodiments the touch screen display 100 may be in a locked or unlocked mode. In the locked mode, a slider selection event may be required before other touch event input (e.g., button touches) will be received and acted upon by the underlying electronic device. However, in some example embodiments, the execution of a slider selection event may trigger execution of functionality associated with a functionality option or a sub-functionality option without otherwise unlocking the electronic device. In this manner, the unintended execution of functionality by the electronic device may be prevented when stray or accidental contact with the display occurs. In the unlocked mode, it may be assumed that the user has control of the device (e.g., the device is not in a pocket or brief case) and full touch capabilities may be provided to the user (e.g., button touches may be received and acted upon). As such, in the unlocked mode any contact with the display may potentially result in the execution of functionality. Further, in some example embodiments, even in the unlocked mode, some precautionary schemes may be implemented to distinguish stray or accidental contact with the display from intended contact with the display.

The display locked/unlocked status 127 may indicate whether the touch screen display 100 is in a locked or unlocked mode. In some example embodiments, when the touch screen display 100 is locked, the display may be unlocked when a user performs a slider selection event that is detected by, for example, a processor via the touch screen display 100. Upon detecting the slider selection event, the processor may transition the electronic device and the touch screen display 100 from a locked mode to an unlocked mode.

Referring to the example scenario depicted in FIG. 1a, an electronic device that includes touch screen display 100 is receiving an incoming call from John Smith and the touch screen display 100 is in a locked mode as indicated by display locked/unlocked status 127. In response to receiving the incoming call, a dynamic slider interface may be presented to the user. As depicted in FIG. 1a, a user may implement a slider selection event to indicate how the electronic device may handle the incoming call. In this example scenario, the call may be rejected and immediately ended if a slider selection event is directed toward functionality location 116 and the reject option 115. Further, the ringer of the phone may be silenced by implementing a slider selection event directed toward the functionality option location 121 and the silence option 120. Additionally, the call may be answered by implementing a slider selection event directed toward the functionality option location 126 and the answer option 125.

FIG. 1b depicts a scenario where the user has implemented a slider selection event to reject the phone call by moving the slider object 110 from the origin location 111 to a destination that is the functionality option location 116 associated with the reject option 115. According to various example embodiments, since a slider selection event has occurred, the electronic device and the touch screen display 100 may transition from the locked mode to the unlocked mode as indicated by the display locked/unlocked status 127.

Further, in some example embodiments, upon execution of the slider selection event, the functionality associated with selected functionality option may be executed. In this regard, referring to FIG. 1b, a rejection of the incoming call from John Smith may be executed. Upon detection of a slider selection event, sub-functionality options also may be dynamically presented on the touch screen 100 as further described with respect to FIG. 1c.

While the example scenario of FIG. 1b involves the rejection of a phone call upon detection of the slider selection event, some example embodiments need not execute functionality other than to present sub-functionality options. In other words, functionality may be executed upon detection of a slider selection event (e.g., reject a phone call) and sub-functionality options may be presented, or no functionality need be executed upon detection of a slider selection event other than to present sub-functionality options. In either case, the presentation of sub-functionality options may allow for related or more specific functionality to be implemented via subsequent slider selection events involving the sub-functionality options.

FIG. 1c illustrates an example presentation of sub-functionality options according to various embodiments of the present invention. In this regard, upon detection of the slider selection event of the reject option 115 in FIG. 1b, a presentation of sub-functionality options may be implemented. The previously available functionality option may be removed from the touch screen display 100 and the slider object 110 may remain in the same location as it was upon completion of the slider selection event. By removing the previously available selections and presenting the sub-functionality options, example embodiments make efficient use of the limited display area provided by many touch screen devices.

The presented sub-functionality options may have an intuitive relationship with the selected functionality option. In this regard, a hierarchal tree of functionality options may be available for selection via the dynamic slider interface. For example, if a functionality option is to answer a call, a sub-functionality option may be to initiate a speaker phone mode. In the example scenario of FIG. 1c, two sub-functionality options are presented that are related to rejecting a call, namely, a send message option 130 and a chat option 135. In this regard, the send message option 130 may be utilized to send a text message to provide information to the caller of the rejected call. The chat option 135 may be utilized to initiate a chat session with the caller of the rejected call.

Further, according to the example embodiment of FIG. 1c, detection of the slider selection event directed to the rejection option 115, causes the incoming call to be disconnected. Accordingly, device status 105 indicates that the electronic device is disconnecting from the call from John Smith.

A user interacting with the touch screen display 100 of FIG. 1c may have various options for proceeding. If a user desires to select a sub-functionality option, the user may implement a slider selection event directed to the desired sub-functionality option. For example, the user may move the slider object 110 to the send message option 130 associated with a functionality option location 131 or the chat option 135 associated with a functionality option location 136. Further, for example, upon implementing the slider selection event that selected the reject option 115 depicted in FIG. 1b, the user may discontinue contact with the touch screen display 100. According to some exemplary embodiments, discontinuing contact with the touch screen display may indicate that a sub-functionality option will not be selected, and no subsequent selection of a sub-functionality option will be permitted. In other example embodiments, discontinuing contact with the touch screen subsequent to a slider selection event for a threshold period of time may result in preventing subsequent selection of a sub-functionality option. In this regard, if a slider selection event were to be initiated prior to the threshold period of time, selection of a sub-functionality option may be permitted. In some embodiments, a sub-functionality option may be selected via a slider selection event that begins without discontinuing contact with the touch screen display 100 from a previous slider selection event.

With regard to the transition between a first slider selection event and a second slider selection event, the destination of the first slider selection event may become the origin of the second slider selection event. For example, referring to FIG. 1b and 1c, a first slider selection event ended at a destination of the functionality option location 116 associated with the reject option 115. Therefore, a second slider selection event may then begin at the same location that the first slider selection event ended. In this regard, the functionality option location 116 may become the origin location 112 for the second slider selection event.

According to the example scenario of FIG. 1d, a slider selection event has been detected where the send message option 130 was selected indicating that the user desires to send a text message. As explained above, the destination (e.g., functionality option location 131) of the slider selection event may now become the origin location 113 for a subsequent slider selection event. In this the regard, according to the example scenario of FIG. 1d, a subsequent slider selection event may be performed that would add default text to the text message, and in some example embodiments, automatically send the text message to the number of the calling device. The user may insert “I will call you later” into the text message when selecting the sub-functionality option 151 by moving the slider 110 to the functionality location 151. Alternatively, the user may insert “I'm in a meeting” into the text message when selecting the sub-functionality option 140 by moving the slider 110 to the functionality location 141. Further, the user may insert “See you at home” into the text message when selecting the sub-functionality option 145 by moving the slider 110 to the functionality location 146.

While FIGS. 1a-1d depict one example scenario that involves functionality associated with answering an incoming phone call, example embodiments of the present invention are also contemplated that involve functionality associated with various other activities and/or application that may be performed on an electronic device with a touch screen display. For example, in another example embodiment aspects of the present invention may be implemented with respect to a media player application. In this regard, the media player application may be executed, for example, by playing a song, and the touch screen display may be locked. In some exemplary embodiments (not limited to media player applications) a hot spot area on the touch screen display may be defined. When a touch event occurs within the hot spot area, a dynamic slider interface involving media player functionality may be presented on the touch screen display.

Functionality options for the media player may include a next track functionality option, a previous track functionality option, a pause functionality option, a volume functionality option, or the like. A slider selection event with respect to any of the functionality options may trigger the associated underlying functionality (e.g., skip to the next track) without otherwise unlocking the touch screen display. In some example embodiments, an unlock functionality option may also be included, such that when a slider selection event with respect to the unlock functionality option occurs, the touch screen display may be unlocked. Further, in some example embodiments, a sub-functionality option for, for example, the volume functionality option may be a volume slider that may move up or down, or right or left, to adjust the volume.

In yet another example embodiment, aspects of the present invention may be implemented with respect to a missed call scenario, where a phone call is received by an electronic device, but the call is not answered. In this regard, a dynamic slider interface may be presented on a touch screen display with functionality options including a store the number option, a call back option, a send text message option, or the like. Further, in another example embodiment, a dynamic slider interface may be presented with respect to a clock/calendar alarm application where the functionality options may include a stop alarm functionality option, a snooze functionality option, or the like. In some example embodiments, sub-functionality options for the snooze functionality option may be a 2 minute snooze time sub-functionality option, a 5 minute snooze time sub-functionality option, a 10 minute snooze time sub-functionality option, or the like. Alternatively, in some example embodiments, a sub-functionality option of the snooze functionality option may be a slider that indicates the snooze time based on how far the slider is moved (e.g., the further the slider is moved, the longer snooze time).

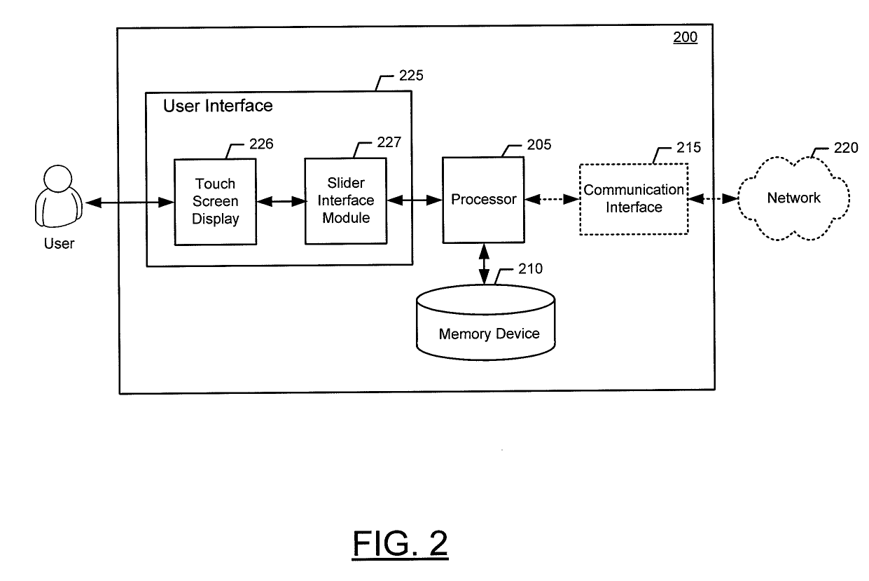

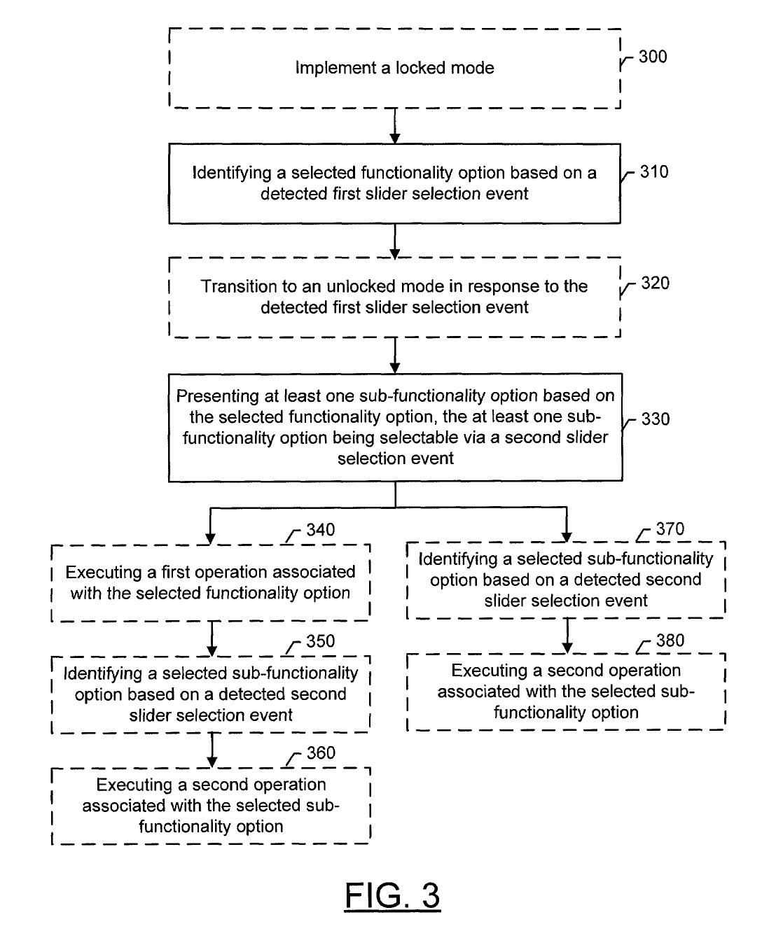

FIG. 2 illustrates an example apparatus 200 configured to implement a slider interface module according to various embodiments of the present invention. The apparatus 200, and in particular the processor 205, may be configured to implement the concepts described in association with FIGS. 1a-1d and as otherwise generally described above. Further, the apparatus 200, and in particular the processor 205 may be configured to carry out some or all of the operations described with respect to FIG. 3.

In some example embodiments, the apparatus 200 may be embodied as, or included as a component of, a computing device and/or a communications device with wired or wireless communications capabilities. Some examples of the apparatus 200 may include a computer, a server, a mobile terminal such as, a mobile telephone, a portable digital assistant (PDA), a pager, a mobile television, a gaming device, a mobile computer, a laptop computer, a camera, a video recorder, an audio/video player, a radio, and/or a global positioning system (GPS) device, a network entity such as an access point such as a base station, or any combination of the aforementioned, or the like. Further, the apparatus 200 may be configured to implement various aspects of the present invention as described herein including, for example, various example methods of the present invention, where the methods may be implemented by means of a hardware or software configured processor (e.g., processor 205), computer-readable medium, or the like.

The apparatus 200 may include or otherwise be in communication with a processor 205, a memory device 210, and a user interface 225. Further, in some embodiments, such as embodiments where the apparatus 200 is a mobile terminal, the apparatus 200 also includes a communications interface 215. The processor 205 may be embodied as various means including, for example, a microprocessor, a coprocessor, a controller, or various other processing devices including integrated circuits such as, for example, an ASIC (application specific integrated circuit), an FPGA (field programmable gate array), or a hardware accelerator. In an example embodiment, the processor 205 is configured to execute instructions stored in the memory device 210 or instructions otherwise accessible to the processor 205. Processor 205 may be configured to facilitate communications via the communications interface 215 by, for example, controlling hardware and/or software included in the communications interface 215.

The memory device 210 may be configured to store various information involved in implementing embodiments of the present invention such as, for example, connectivity stability factors. The memory device 210 may be a computer-readable storage medium that may include volatile and/or non-volatile memory. For example, memory device 210 may include Random Access Memory (RAM) including dynamic and/or static RAM, on-chip or off-chip cache memory, and/or the like. Further, memory device 210 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 210 may include a cache area for temporary storage of data. In this regard, some or all of memory device 210 may be included within the processor 205.

Further, the memory device 210 may be configured to store information, data, applications, computer-readable program code instructions, or the like for enabling the processor 205 and the apparatus 200 to carry out various functions in accordance with example embodiments of the present invention. For example, the memory device 210 could be configured to buffer input data for processing by the processor 205. Additionally, or alternatively, the memory device 210 may be configured to store instructions for execution by the processor 205.

The communication interface 215 may be any device or means embodied in either hardware, software, or a combination of hardware and software that is configured to receive and/or transmit data from/to a network and/or any other device or module in communication with the apparatus 200. In this regard, the communication interface 215 may include, for example, an antenna, a transmitter, a receiver, a transceiver and/or supporting hardware, including a processor or software for enabling communications with network 220. In some example embodiments, network 220 may exemplify a peer-to-peer connection. Via the communication interface 215, the apparatus 200 may communicate with various other network entities.

The communications interface 215 may be configured to provide for communications in accordance with any wired or wireless communication standard. For example, communications interface 215 may be configured to provide for communications in accordance with second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 215 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like.

The user interface 225 may be in communication with the processor 205 to receive user input at the user interface 225 and/or to provide output to a user as, for example, audible, visual, mechanical or other output indications. The user interface 225 may include, for example, a keyboard, a mouse, a joystick, a microphone, a speaker, or other input/output mechanisms.

The user interface 225 may also include touch screen display 226. Touch screen display 226 may be configured to visually present graphical information to a user. Touch screen display 226, which may be embodied as any known touch screen display, may also include a touch detection surface configured to enable touch recognition by any suitable technique, such as resistive, capacitive, infrared, strain gauge, surface wave, optical imaging, dispersive signal technology, acoustic pulse recognition, or other like techniques. The touch screen display 226 may include all of the hardware necessary to detect a touch when contact is made with the touch detection surface. A touch event may occur when an object, such as a stylus, finger, pen, pencil or any other pointing device, comes into contact with a portion of the touch detection surface of the touch screen display 226 in a manner sufficient to register as a touch. In this regard, for example, a touch could be a detection of pressure on the touch detection surface above a particular pressure threshold over a given area. The touch screen display 226 may also be configured to generate touch event location data indicating the location of the touch event on the screen. Touch screen display may be configured to provide the touch event location data to other entities (e.g., the slider interface module 227 and/or the processor 205).

In some embodiments, touch screen display 226 may be configured to detect a touch followed by motion across the touch detection surface, which may also be referred to as a gesture. In this regard, for example, the movement of a finger across the touch detection surface of the touch screen display 226 may be detected and touch event location data may be generated that describes the gesture generated by the finger. In other words, the gesture may be defined by motion following a touch thereby forming a continuous, moving touch event defining a moving series of instantaneous touch positions. The gesture may represent a series of unbroken touch events, or in some cases a combination of separate touch events.

The user interface 225 may also include a slider interface module 227. While the example apparatus 200 includes the slider interface module 227 within the user interface 225, according to various example embodiments, slider interface module 227 need not be included in user interface 225. The slider interface module 227 may be any means or device embodied in hardware, software, or a combination of hardware and software, such as processor 205 implementing software instructions or a hardware configured processor 205, that is configured to carry out the functions of the slider interface module 227 as described herein. In an example embodiment, the processor 205 may include, or otherwise control the slider interface module 227. The slider interface module 227 may be in communication with the processor 205 and the touch screen display 226. Further, the slider interface module may be configured to control the touch screen display 226 to present graphics on the touch screen display 226 and receive touch event location data to implement a dynamic slider interface.

The slider interface module 227 may be configured to identify a selected functionality option based on a detected first slider selection event on a touch screen display. Further, the slider interface module may also be configured to present, in response to identifying the selected functionality option, at least one sub-functionality option on the touch screen display based on the selected functionality option. The at least one sub-functionality option may be selectable via a second slider selection event.

In some example embodiments, the slider interface module 227 is configured to execute or initiate the execution of a first operation associated with the selected functionality option. Based on a detected second slider selection event, the slider interface module 227 may be configured to identify a selected sub-functionality option. The slider interface module may also be configured to execute a second operation associated with the selected sub-functionality option. According to various example embodiments, the origin of the second slider selection event may be a destination of the first slider selection event.

Alternatively or additionally, the slider interface module 227 may be configured to identify a selected sub-functionality option based on a detected second slider selection event and execute an operation associated with the selected functionality option and the selected sub-functionality option. According to various example embodiments, the origin of the second slider selection event may be a destination of the first slider selection event. Further, in some example embodiments, the slider interface module 227 is configured to implement a locked mode prior to identifying the selected functionality option and transition to an unlocked mode in response to the detected first slider selection event.

FIG. 3 illustrates a flowchart of a system, method, and computer program product according to example embodiments of the invention. It will be understood that each block, step, or operation of the flowchart, and/or combinations of blocks, steps, or operations in the flowchart, may be implemented by various means. Example means for implementing the blocks, steps, or operations of the flowchart, and/or combinations of the blocks, steps or operations in the flowchart include hardware, firmware, and/or software including one or more computer program code instructions, program instructions, or executable computer-readable program code instructions. Example means for implementing the blocks, steps, or operations of the flowchart, and/or combinations of the blocks, steps or operations in the flowchart also include a processor such as the processor 205. The processor may, for example, be configured to perform the operations of FIG. 3 by performing hardware implemented logical functions, executing stored instructions, or executing algorithms for performing each of the operations. Alternatively, an example apparatus may comprise means for performing each of the operations of the flowchart. In this regard, according to an example embodiment, examples of means for performing the operations of FIG. 3 include, for example, the processor 205, the slider interface module 227, and/or an algorithm executed by the processor 205 for processing information as described herein.

In one example embodiment, one or more of the procedures described herein are embodied by program code instructions. In this regard, the program code instructions which embody the procedures described herein may be stored by or on a memory device, such as memory device 210, of an apparatus, such as apparatus 200, and executed by a processor, such as the processor 205. As will be appreciated, any such program code instructions may be loaded onto a computer, processor, or other programmable apparatus (e.g., processor 205, memory device 210) to produce a machine, such that the instructions which execute on the computer, processor, or other programmable apparatus create means for implementing the functions specified in the flowchart's block(s), step(s), or operation(s). In some example embodiments, these program code instructions are also stored in a computer-readable storage medium that directs a computer, a processor, or other programmable apparatus to function in a particular manner, such that the instructions stored in the computer-readable storage medium produce an article of manufacture including instruction means which implement the function specified in the flowchart's block(s), step(s), or operation(s). The program code instructions may also be loaded onto a computer, processor, or other programmable apparatus to cause a series of operational steps to be performed on or by the computer, processor, or other programmable apparatus to produce a computer-implemented process such that the instructions which execute on the computer, processor, or other programmable apparatus provide steps for implementing the functions specified in the flowchart's block(s), step(s), or operation(s).

Accordingly, blocks, steps, or operations of the flowchart support combinations of means for performing the specified functions, combinations of steps for performing the specified functions, and program code instruction means for performing the specified functions. It will also be understood that, in some example embodiments, one or more blocks, steps, or operations of the flowchart, and combinations of blocks, steps, or operations in the flowchart, are implemented by special purpose hardware-based computer systems or processors which perform the specified functions or steps, or combinations of special purpose hardware and program code instructions.

FIG. 3 depicts a flowchart describing an example method for providing a dynamic slider interface for use with touch screen devices. According to some example embodiments, at 300, the method may include implementing a locked mode. Further, at 310 the example method includes identifying a selected functionality option. The selected functionality option may be selected based on a detected first slider selection event. In some example embodiments, at 320 the example method may include transitioning to an unlocked mode in response to the detected first slider selection event. At 330, at least one sub-functionality option may be presented in response to identifying the selected functionality option. Further, the at least one sub-functionality option may be determined based on the selected functionality option. The at least one sub-functionality option may also be selectable via a second slider selection event.

Subsequent to presenting the at least one sub-functionality option at 330, the example method may follow alternative paths. A first alternative path may include executing a first operation associated with the selected functionality option at 340. The first alternative path may also include identifying a selected sub-functionality option based on a detected second slider selection event at 350, and executing a second operation associated with the selected sub-functionality option at 360. In this regard, according to some example embodiments, an origin of the second slider selection event may be a destination of the first slider selection event.

A second alternative path of the example method following from 330 may include identifying a selected sub-functionality option based on a detected second slider selection event at 370. The second alternative path may also include executing an operation associated with the selected functionality option and the selected sub-functionality option at 380. In this regard, according to some example embodiments, an origin of the second slider selection event may be a destination of the first slider selection event.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
identifying a selected functionality option based on a detected first slider selection event on a touch screen display; and
presenting, in response to identifying the selected functionality option, at least one sub-functionality option on the touch screen display based on the selected functionality option, the at least one sub-functionality option being selectable via a second slider selection event, and wherein presenting the at least one sub-functionality option on the touch screen display is performed via a processor.

2. The method of claim 1 further comprising executing a first operation associated with the selected functionality option.

3. The method of claim 2 further comprising:
identifying a selected sub-functionality option based on a detected second slider selection event; and
executing a second operation associated with the selected sub-functionality option.

4. The method of claim 1 further comprising:
identifying a selected sub-functionality option based on a detected second slider selection event; and
executing an operation associated with the selected functionality option and the selected sub-functionality option.

5. The method of claim 4 wherein identifying the selected sub-functionality option based on a detected second slider selection event includes detecting the second slider selection event wherein an origin of the second slider selection event is a destination of the first slider selection event.

6. An apparatus comprising a processor, the processor configured to:
identify a selected functionality option based on a detected first slider selection event on a touch screen display; and
present, in response to identifying the selected functionality option, at least one sub-functionality option on the touch screen display based on the selected functionality option, the at least one sub-functionality option being selectable via a second slider selection event.

7. The apparatus of claim 6, wherein the processor is further configured to execute a first operation associated with the selected functionality option.

8. The apparatus of claim 7, wherein the processor is further configured to:
identify a selected sub-functionality option based on a detected second slider selection event; and
execute a second operation associated with the selected sub-functionality option.

9. The apparatus of claim 8, wherein the processor is further configured to:
identify a selected sub-functionality option based on a detected second slider selection event; and
execute an operation associated with the selected functionality option and the selected sub-functionality option.

10. The apparatus of claim 9 wherein the processor configured to identify the selected sub-functionality option based on a detected second slider selection event includes being configured to detect the second slider selection event wherein an origin of the second slider selection event is a destination of the first slider selection event.

11. The apparatus of claim 10, wherein the processor is further configured to:
implement a locked mode prior to identifying the selected functionality option; and
transition to an unlocked mode in response to the detected first slider selection event.

12. The apparatus of claim 6 further comprising the touch screen display in communication with the processor.

13. An computer program product comprising at least one computer-readable storage medium having executable computer-readable program code instructions stored therein, the computer-readable program code instructions configured to:
identify a selected functionality option based on a detected first slider selection event on a touch screen display; and
present, in response to identifying the selected functionality option, at least one sub-functionality option on the touch screen display based on the selected functionality option, the at least one sub-functionality option being selectable via a second slider selection event.

14. The computer program product of claim 13, wherein the computer-readable program code instructions are further configured to execute a first operation associated with the selected functionality option.

15. The computer program product of claim 14, wherein the computer-readable program code instructions are further configured to:
identify a selected sub-functionality option based on a detected second slider selection event; and
execute a second operation associated with the selected sub-functionality option.

16. The computer program product of claim 13, wherein the computer-readable program code instructions are further configured to:
identify a selected sub-functionality option based on a detected second slider selection event; and
execute an operation associated with the selected functionality option and the selected sub-functionality option.

17. The computer program product of claim 16 wherein the computer-readable program code instructions configured to identify the selected sub-functionality option based on a detected second slider selection event include being configured to detect the second slider selection event wherein an origin of the second slider selection event is a destination of the first slider selection event.

18. The computer program product of claim 13, wherein the computer-readable program code instructions are further configured to:
implement a locked mode prior to identifying the selected functionality option; and
transition to an unlocked mode in response to the detected first slider selection event.

19. An apparatus comprising:
means for identifying a selected functionality option based on a detected first slider selection event on a touch screen display; and
means for presenting, in response to identifying the selected functionality option, at least one sub-functionality option on the touch screen display based on the selected functionality option, the at least one sub-functionality option being selectable via a second slider selection event.

20. The apparatus of claim 19 further comprising:
means for identifying a selected sub-functionality option based on a detected second slider selection event; and
means for executing an operation associated with the selected functionality option and the selected sub-functionality option.
